(19) United States
(12) Patent Application Publication
(10) Pub. No.: US 2004/0113768 A1
(43) Pub. Date: Jun. 17, 2004

(54) Communication system

(76) Inventor: Stephen Fredrick Rodgers, Johannesburg (ZA)

Correspondence Address: CHRISTIE, PARKER & HALE, LLP, 350 WEST COLORADO BOULEVARD, SUITE 500, PASADENA, CA, 91105, US

(21) Appl. No.: 10/466,260

(22) PCT Filed: Jan. 17, 2002
(86) PCT No.: PCT/IB02/00109

(30) Foreign Application Priority Data
Jan. 17, 2001 (ZA) 2001/0469
Dec. 6, 2001 (ZA) 2001/10047

(51) Int. Cl. G08B 29/00

(52) U.S. Cl. 340/506; 340/531

(57) ABSTRACT

A communication system for disseminating alarm messages comprises a control facility accessible by at least one communication channel and operable to receive and alarm signal via the at least one communication channel signifying the occurrence of an alarm event; identification means operably connected to the control facility and operable automatically to identify the source of the alarm signal; an information database of authorized sources of alarm signals, the information database accessible by the control facility and containing, for each authorized source, contact details of at least one recipient to whom at least one predetermined alarm message is to be disseminated in response to receipt of the alarm signal; and dissemination means operably connected to the control means and operable, in response to receipt of an alarm signal by the control means from an authorized source, automatically to transmit the at least one predetermined alarm message to the at least one recipient. The invention extends to a method of disseminating an alarm message.

### FIELD OF THE INVENTION

This invention relates to a communication system and, more particularly, to a communication system which can be employed in emergency situations where an alarm message must be disseminated to recipients. The invention extends to a method of disseminating an alarm message.

### BACKGROUND TO THE INVENTION

Many countries in the world have emergency rescue services which may be accessed by a person in distress to provide details of the nature of the emergency, the caller's name and the caller's location. The emergency rescue service will respond by dispatching one or more agency to the scene of the emergency, such as the police, paramedical personnel or the fire department. One example of such an emergency service is the well-known “911” emergency rescue service.

A problem with such emergency rescue services is that a relatively lengthy conversation is necessary in order for effective help to be dispatched to the scene of an emergency. The details required to dispatch such help, such as the location and identity of the person in distress, are not readily available to the rescue service. If the service is busy, then it can take some time before the telephone call is answered, and time is of the essence in emergency situations. Furthermore, such emergency rescue services provide only a single point of contact. Consequently, other parties who may be able to provide help more quickly than the emergency rescue services remain unaware of the emergency situation. It is often desirable that a family member or a personal contact of the caller in distress be at the scene of an emergency to assist emergency rescue services in executing their duties.

Where the emergency involves incursion into property or tampering with an article rather than injury to a person, similar considerations arise.

### OBJECT OF THE INVENTION

It is an object of this invention to provide a communication system and a method of disseminating an alarm message, which will, at least partially, alleviate the aforementioned difficulties and disadvantages.

### SUMMARY OF THE INVENTION

According to a first aspect of the invention there is provided a communication system for disseminating alarm messages, the system comprising

a control facility accessible by at least one communication channel and operable to receive an alarm signal via the at least one communication channel signifying the occurrence of an alarm event;

identification means operably connected to the control facility and operable automatically to identify the source of the alarm signal;

an information database of authorized sources of alarm signals, the information database accessible by the control facility and containing, for each authorized source, contact details of at least one recipient to whom at least one predetermined alarm message is to be disseminated in response to receipt of the alarm signal; and

dissemination means operably connected to the control means and operable, in response to receipt of an alarm signal by the control means from an authorized source, automatically to transmit the at least one predetermined alarm message to the at least one recipient.

According to a second aspect of the invention there is provided a method for disseminating alarm messages, the method including

receiving, at a control facility of a communication system, via a communication channel, an alarm signal signifying the occurrence of an alarm event;

identifying automatically a source of the alarm signal;

searching automatically an information database of authorized sources of alarm signals to determine whether the source of the alarm signal is an authorized source;

if the source of the alarm signal is an authorized source, determining automatically from an information database containing, for each authorized source, contact details of at least one recipient to whom at least one predetermined alarm message is to be disseminated in response to receipt of an alarm signal, the contact details of said at least one recipient associated with the source of the alarm signal; and

disseminating automatically the at least one predetermined alarm message to the at least one recipient.

The content of the at least one alarm message may be determinable, at least in part, by an authorized user of the system associated with the source of the alarm signal in response to which the at least one alarm message is to be disseminated.

The information database may contain, for each authorized source, an authorized user of the communication system associated with the said source, the database comprising data files relating to each of the authorized users. Then, as far as the second aspect of the invention is concerned, the method may include the step of automatically searching the information database to identify an authorized user of the communication system associated with the source of the alarm signal.

Each data file may contain information including personal particulars of the respective authorized user, contact details of the, or each, recipient to whom the at least one predetermined message is to be disseminated in response to receipt of an alarm signal, and at least a portion of the at least one predetermined alarm message. The, or a, communication channel may be operable by at least one communication instrument, the instrument being the source of the alarm signal. The communication instrument may be any one of a mobile telecommunication handset or a fixed-line telecommunication handset. Instead, the communication instrument may be an Internet-enabled computer workstation. Further instead, the communication instrument may be a radio-frequency transmitter.

The identification means may be a caller line identification (CLI) facility configured to identify the communication instrument comprising the source of the alarm signal. Then the CLI facility may be configured to identify the communication instrument as a function of the telephone access number of that communication instrument stored in the information database.

The information database may comprise data files relating to each of the authorized users of the communication system associated with an authorized source, each data file including, but not limited to, particulars of the communication instrument associated with the particular authorized user and its associated telephone access number, the geographic location of the communication instrument if it is a fixed line telecommunication handset, or a list of possible geographic locations of the communication instrument if it is a mobile telecommunication handset, and billing particulars of the user of the system.

The dissemination means may include a voice dissemination means. Further, the dissemination means may include a data dissemination means. The voice dissemination means may include a fixed-line telecommunication network. Further, the voice dissemination means may include a mobile telecommunication network. The data dissemination means may comprise a messaging facility. Then the messaging facility may be a Short Message Service (SMS) messaging service of a mobile telecommunication network. Instead, the messaging facility may be an Internet-based electronic mail service.

The information database may include, for each authorized source, parameters relating to operation of the dissemination means. Then, as far as the second aspect of the invention is concerned, the method may include operating the dissemination means in accordance with the said parameters. The parameters may include the number of times a telephone access number should be re-tried in the event of an unsuccessful dissemination of predetermined alarm message, and a number of rings allowed before a telephone call is deemed unsuccessful, and the number of times a messaging address should be re-tried in the event of an unsuccessful dissemination of predetermined alarm message.

In a preferred embodiment of the invention, the control facility has a plurality of access addresses for accessing by the at least one communication channel to receive the alarm signal and, for at least one authorized source, the associated data files contains a plurality of sets of contact details of recipients and a plurality of alarm messages, each set of contact details and each alarm message being associated with a respective one of the access addresses of the control means, the dissemination means being operable under control of the control means, in response to receipt of an alarm signal at an access address, to disseminate a preselected message to a set of recipients associated with the respective access address at which the alarm signal is received.

Then, as far as the second aspect of the invention is concerned, the method may include the steps of

identifying the access address accessed in receiving the alarm signal; and disseminating a preselected message to a set of recipients associated with the respective access address at which the alarm signal is received.

In a further preferred embodiment of the invention, where the information database contains identities authorized users, the control facility has a plurality of access addresses for accessing by the at least one communication channel to receive the alarm signal and, for at least one authorized user of the system, the associated data files contain a plurality of sets of contact details of recipients and a plurality of alarm messages, each set of contact details and each alarm message being associated with a respective one of the access addresses of the control means, the dissemination means being operable under control of the control means, in response to receipt of an alarm signal at an access address, to disseminate a preselected message to a set of recipients associated with the respective access address at which the alarm signal is received.

Then, as above, as far as the second aspect of the invention is concerned, the method may include the steps of

identifying the access address accessed in receiving the alarm signal; and

disseminating a preselected message to a set of recipients associated with the respective access address at which the alarm signal is received.

The communication system may include a billing facility operable to bill the authorized user for use of the system, and in which the information database contains billing particulars of each authorized user. Then, as far as the second aspect of the invention is concerned, the method may include the step of billing an authorized user for use of the system.

The invention extends to a communication system, as hereinbefore described, in combination with a plurality of mobile telephones, each mobile telephone being operable to provide a source of an alarm signal and in which the control facility of the communication system is accessible by a mobile telephone network.

Further, the invention extends to a communication system, as hereinbefore described, in combination with a plurality of transmitters, each of which is locatable on a vehicle to be protected and activatable to transmit an alarm signal via a mobile telephone network on detection of unauthorized tampering with the vehicle, thereby providing a source of an alarm signal and in which the control facility of the communication system is accessible by a mobile telephone network.

### BRIEF DESCRIPTION OF THE DRAWINGS

The invention is now described, by way of example, with reference to the accompanying drawings, in which:

FIG. 1 is a schematic representation of a first embodiment of a communication system for disseminating alarm messages, according to the invention; and

FIG. 2 is a schematic representation of a second embodiment of the communication system.

### DETAILED DESCRIPTION OF THE INVENTION

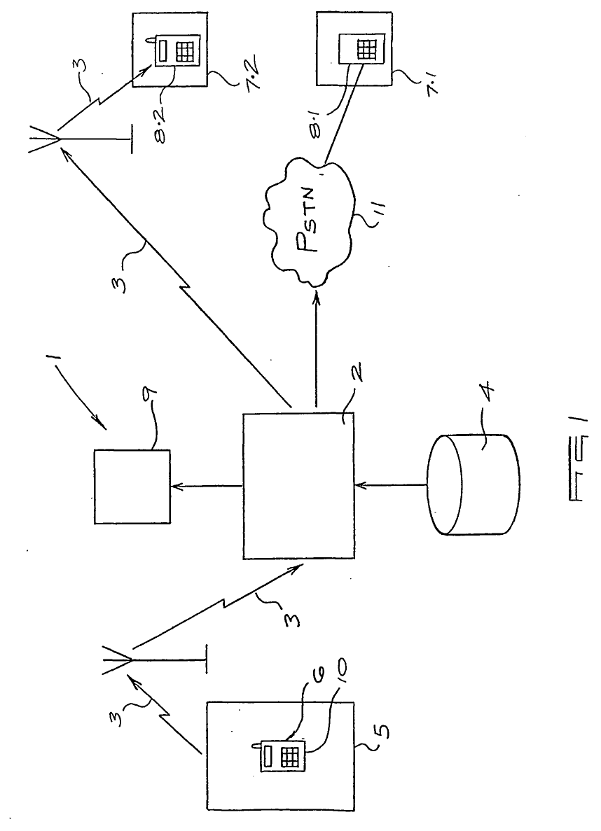

Referring to FIG. 1, a communication system for disseminating alarm messages is indicated generally by reference numeral (1).

The communication system (1) comprises a control facility (2) having an information database (4), and which is accessible by an authorized user (5) by means of a communication channel (3). The control facility (2) is a computer. It will be appreciated that the control facility (2) may comprise a personal computer, computer file server, or the like. In this embodiment, the communication channel (3) is a mobile telecommunication network. The authorized user (5) is shown remote from the control facility (2) with access to the communication channel (3) provided by means of a communication instrument (6) in the form of a mobile telecommunication handset. The telecommunication handset (6) provides a source (10) for the transmission of alarm signals. A pair of recipients (7) is shown remote from the control facility (2). The recipients (7) are accessible by the control facility (2) by means of further communication instruments (8). The communication system (1) also includes a billing facility (9).

The information database (4) contains information relating to all authorized sources (10) of the communication system (1) and consists of a plurality of data files, each of which corresponding to a respective authorized source (10). A data file corresponding to a particular authorized source (10) includes personal particulars of the authorized user (5), particulars of the mobile telecommunication handset (6) belonging to the authorized user (5) and its associated telephone access number, a list of possible geographical locations of the mobile telecommunication handset, contact details of a number of recipients (7) to be contacted in the event of an emergency situation arising, and billing details such as bank account details of the authorized user (5).

In the event of a distress situation of any sort arising for the authorized user (5) such as, for example, a breach of the authorized user's physical security, or a medical emergency, the authorized user (5) accesses the control facility (2) by means of the mobile telecommunication network (3) by dialling a telephone access number of the control facility (2) on the user's mobile telecommunication handset (6). Preferably, the handset (6) is configured to access the telephone access number of the control facility (2) by means of a speed dialling function so that the authorized user (5) in distress can use the speed dialling functionality on his mobile telecommunication handset (6) to dial the requisite telephone access number of the control facility (2), thereby using only a single keystroke to dial the control facility (2). Operation of the speed dialling facility by the authorized user (5) in distress results in an alarm signal being transmitted to the control facility (2). The distress call from the authorized user (5) is received at the control facility (2) and an identification means in the form of a Caller Line Identification (CLI) system (not shown) identifies the telephone access number of the source (10), being in this embodiment the mobile telecommunication handset (6), from which the distress call has been made. The CLI system also identifies the access number of the control facility (2) that has been used to make the distress call. It will be appreciated that it is not necessary for the authorized user (5) to speak to convey the alarm message. The mere fact of accessing the control facility (2) enables the CLI system to identify the source (10) of the telephone call without the call actually being answered or a message spoken.

Once the source (10) of the alarm signal has been identified in this manner, the information database (4) is accessed in order to locate the data file corresponding to that source (10). Once the data file has been located as described above, the control facility (2) then identifies:

the personal details of the authorized user in distress, such as the user's name and physical address.

the geographical location of the mobile telecommunication handset (6) from which the distress call was made. This is determined using the CLI system to identify the telephone access number of the control facility (2), which was used to dial the control facility (2). The data file contains, for each telephone access number available for dialling, a respective geographical location. Thus, based on the telephone access number accessed by the mobile telephone network (3), the control facility (2) identifies which of the multiple locations recorded in the information database (4) for the authorized user's mobile telecommunication handset (6) is the current geographical location of the authorized user (5) in distress. It will be appreciated that in order for this feature of the communication system (1) to be workable, an authorized user (5) of the system (1) must anticipate that he may wish to transmit a distress signal from a specific geographical location, such as, for example, his home, work address, or the like. The use of a specific telephone access number for the control facility (2) is then taken as indicative of the fact that the authorized user (5) is at the preselected location.

the contact details of at least one recipient (7) that the authorized user wishes to alert of the distress situation. It is envisaged that an authorized user (5) may select a plurality of recipients (7), all of whom will be alerted of the distress situation. In FIG. 1, two such recipients (7.1,7.2) are shown. Recipient (7.1) is accessed via a Public Switched Telephone Network (PSTN) (11) and his contact details comprise his telephone number of a PSTN handset (8.1). Recipient (7.2) is accessed via the mobile telecommunication network (3) and his contact details comprise the mobile telephone number of his mobile telephone (8.2).

a predetermined alarm message that is to be disseminated to the recipients, and the method of dissemination. The predetermined alarm message can be sent to the intended recipients by means of voice or data transmission. The voice transmission is by way of a telephone call on the mobile telecommunication network, while the data transmission is by way of a messaging service such as a Short Message Service (SMS) of the mobile telecommunication network, or an Internet-based electronic mail service. The substance of the predetermined alarm message is stored in the information database (4) in the form of a text message or a voice message, or both. It will be appreciated that the content of the alarm messages may be determined, in whole or in part, by the authorized user (5).

details of a desired number retries in the event delivery of the predetermined alarm message to any one of the intended recipients is unsuccessful, and the minimum number of rings allowed before a telephone number is answered.

The communication system (1) then automatically disseminates the predetermined alarm message to the recipients (7) in accordance with the information identified and retrieved from the information database (4). The predetermined alarm message will, typically, include the details of the authorized user's name, the authorized users current location and an indication that the authorized user (5) requires assistance. An example of such a message is. “This is an emergency telephone call. A member of the ‘Bloggs’ family is at home, 171 Riviera Drive, Johannesburg, and urgently requires your assistance.” It will be appreciated that each alarm message may be transmitted to a plurality of recipients, such as (7.1) and (7.2). Further, by making use of the plurality of access addresses offered by the control facility (2), the authorized user (5) may customise his service so that, for example, on suffering a medical emergency, he accesses a first access address and the control facility (2) disseminates a predetermined medical alarm message to one, or more, preselected medically qualified recipients, such as a doctor (7.1). On being confronted with a threat to security, however, the authorized user (5) may access a second access address and the control facility (2) will then disseminate a predetermined security alarm message to one, or more, preselected security personnel, such as an armed response service (7.2).

It will be appreciated that the communication system (1) is completely automated. An authorized user (5) need only dial a single number on a mobile telecommunication handset (6) and a plurality of recipients, as determined by that authorized user (5), will be immediately notified of the identity of the user (5), the user's current location and the fact that the user (5) is in distress and requires assistance.

The billing facility (9) is operable by an operator of the communication system (1) to bill any authorized user (5) of the system in accordance with that user's use of the system resources.

Numerous modifications are possible to this embodiment without departing from the scope of the invention. For example, the communication instrument may be a fixed line telecommunication handset instead of a mobile telecommunication handset. It will be appreciated that where the authorized user's communication instrument is a fixed line communication handset, the geographical location of the authorized user (5) in distress will be immediately and uniquely known. Further, where the user (5) uses an SMS to contact the control facility (2), the written message may indicate the current location of the user (5). Still further, the communication instrument may be an Internet-enabled computer workstation with an electronic mail facility.

The invention therefore provides a communication system for disseminating alarm messages (1) which is easily accessible by an authorized user in distress, and which automatically disseminates a predetermined alarm message to a configurable number of recipients as desired by the authorized user.

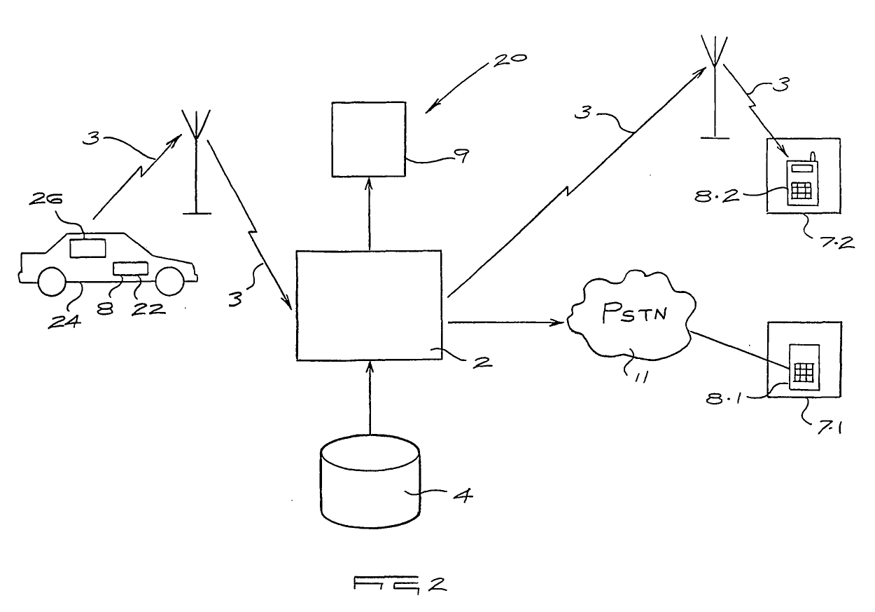

Turning to FIG. 2, a further embodiment of the communication system is indicated generally by reference numeral (20). In FIG. 2, with reference to the communication system (1) of FIG. 1, like numerals indicate like components, unless otherwise stated.

The communication system (20) is similar to that of FIG. 1. However, the source (8) of the alarm signal is provided by a Global System for Mobile Communication (GSM) transmitter (22) which is mounted within an authorized vehicle (24). The GSM transmitter (22) is operable on activation to transmit an identification code of the authorized vehicle (24). The information database (4) contains information relating to all authorized vehicles (24) associated with the communication system (22) and consists of a data file corresponding to each authorized vehicle (24), which includes personal particulars of a proprietor of the authorized vehicle (24), an identification code associated with the authorized vehicle (24), contact details of the proprietor, contact details of a number of recipients (7) to whom the at least one predetermined alarm message is to be disseminated in response to operation of the communication channel by the GSM transmitter (22), and billing details such as bank account details of the proprietor of the authorized vehicle (24). For convenience, the identification codes associated with all of the authorized vehicles are stored in a lookup table (not shown).

In the event of unauthorized tampering with the authorized vehicle (24), an actuator (not shown) activates the transmitter (22) to access the communication channel (3) and transmits to the control facility (2) an identification code associated with the vehicle (24). The identification code is received at the control facility (2) and an identification means in the form of a lookup facility obtains from the lookup table an identification of the authorized vehicle (24) that has undergone tampering, by matching the received identification code with a corresponding entry in the lookup table.

As described above in respect of the embodiment of FIG. 1, the control facility then accesses the information database (4), retrieves the relevant information contained therein, and controls the dissemination of the preselected alarm messages to the respective preselected recipients (7). The predetermined alarm message will, typically, include the details of the proprietor of the authorized vehicle (24), and an indication that the authorized vehicle (24) has been illegally tampered with.

It will be appreciated that the communication system (20) is completely automated. The proprietor of an authorized vehicle (24) need not himself take any action to ensure that a plurality of recipients (7), as determined by that proprietor, will be immediately notified of the unauthorized tampering.

In one variation of the communication system (20), the authorized vehicle (24) also has a Global Positioning System (GPS) transponder (26) fitted thereto. In this variation of the embodiment, the transmitter (22) accesses the communication channel (3) and transmits to the control facility (2) the identification code associated with the vehicle (24) together with data corresponding to geographical co-ordinates of the location of the vehicle (24), as provided by the GPS transponder. The predetermined notification message that is disseminated to the recipients (7) can then also include the geographical co-ordinates of the authorized vehicle (24) in order to facilitate the provision of necessary assistance.

Thus, the invention further provides a communication system which is automatically activatable upon detection of unauthorized tampering with the article or space, and which automatically disseminates a predetermined alarm message to a configurable number of recipients as desired by a proprietor of the article or space.

1. A communication system for disseminating alarm messages, the system comprising
a control facility accessible by at least one communication channel and operable to receive an alarm signal via the at least one communication channel signifying the occurrence of an alarm event;
identification means operably connected to the control facility and operable automatically to identify the source of the alarm signal;
an information database of authorized sources of alarm signals, the information database accessible by the control facility and containing, for each authorized source, contact details of at least one recipient to whom at least one predetermined alarm message is to be disseminated in response to receipt of the alarm signal; and
dissemination means operably connected to the control means and operable, in response to receipt of an alarm signal by the control means from an authorized source, automatically to transmit the at least one predetermined alarm message to the at least one recipient.

2. The communication system as claimed in claim 1 in which the content of the at least one alarm message is determinable, at least in part, by an authorized user of the system associated with the source of the alarm signal in response to which the at least one alarm message is to be disseminated.

3. The communication system as claimed in claim 1 or claim 2, in which the information database contains, for each authorized source, an authorized user of the communication system associated with the said source, the database comprising data files relating to each of the authorized users.

4. The communication system as claimed in claim 3, in which each data file contains information including personal particulars of the respective authorized user, contact details of the, or each, recipient to whom the at least one predetermined message is to be disseminated in response to receipt of an alarm signal, and at least a portion of the at least one predetermined alarm message.

5. The communication system as claimed in any one of the preceding claims, in which the, or a, communication channel is operable by at least one communication instrument, the instrument being the source of the alarm signal.

6. The communication system as claimed in claim 5 in which the communication instrument is any one of a mobile telecommunication handset or a fixed-line telecommunication handset.

7. The communication system as claimed in claim 5, in which the communication instrument is an Internet-enabled computer workstation.

8. The communication system as claimed in claim 5, in which the communication instrument is a radio-frequency transmitter.

9. The communication system as claimed in claim 6 in which the identification means is a caller line identification (CLI) facility configured to identify the communication instrument comprising the source of the alarm signal.

10. The communication system as claimed in claim 9, in which the CLI facility is configured to identify the communication instrument as a function of the telephone access number of that communication instrument stored in the information database.

11. The communication system as claimed in claim 6, in which the information database comprises data files relating to each of the authorized users of the communication system associated with an authorised source, each data file including particulars of the communication instrument associated with the particular authorized user and its associated telephone access number, the geographic location of the communication instrument if it is a fixed line telecommunication handset, or a list of possible geographic locations of the communication instrument if it is a mobile telecommunication handset.

12. The communication system as claimed in any one of the preceding claims, in which the dissemination means includes a voice dissemination means.

13. The communication system as claimed in any one of claims 1 to 11, in which the dissemination means includes a data dissemination means.

14. The communication system as claimed in claim 12, in which the voice dissemination means includes a fixed-line telecommunication network.

15. The communication system as claimed in claim 12, in which the voice dissemination means includes a mobile telecommunication network.

16. The communication system as claimed in claim 13, in which the data dissemination means comprises a messaging facility.

17. The communication system as claimed in claim 16, in which the messaging facility is a Short Message Service (SMS) messaging service of a mobile telecommunication network.

18. The communication system as claimed in claim 16, in which the messaging facility is an Internet-based electronic mail service.

19. The communication system as claimed in claim 1, in which the information database includes, for each authorized source, parameters relating to operation of the dissemination means.

20. The communication system as claimed in claim 14 or claim 15, in which the information database includes, for each authorized user, parameters relating to operation of the dissemination means including the number of times a telephone access number should be re-tried in the event of an unsuccessful dissemination of predetermined alarm message, and a number of rings allowed before a telephone call is deemed unsuccessful.

21. The communication system as claimed in any one of claims 16 to 18, in which the information database includes, for each authorized user, parameters relating to operation of the dissemination means including the number of times a messaging address should be re-tried in the event of an unsuccessful dissemination of predetermined alarm message.

22. The communication system as claimed in claim 1, in which the control facility has a plurality of access addresses for accessing by the at least one communication channel to receive the alarm signal and in which, for at least one authorized source, the associated data files contain a plurality of sets of contact details of recipients and a plurality of alarm messages, each set of contact details and each alarm message being associated with a respective one of the access addresses of the control means, the dissemination means being operable under control of the control means, in response to receipt of an alarm signal at an access address, to disseminate a preselected message to a set of recipients associated with the respective access address at which the alarm signal is received.

23. The communication system as claimed in claim 3, in which the control facility has a plurality of access addresses for accessing by the at least one communication channel to receive the alarm signal and in which, for at least one authorized user of the system, the associated data files contain a plurality of sets of contact details of recipients and a plurality of alarm messages, each set of contact details and each alarm message being associated with a respective one of the access addresses of the control means, the dissemination means being operable under control of the control means, in response to receipt of an alarm signal at an access address, to disseminate a preselected message to a set of recipients associated with the respective access address at which the alarm signal is received.

24. The communication system as claimed in any one of the preceding claims, which includes a billing facility operable to bill the authorized user for use of the system, and in which the information database contains billing particulars of each authorized user.

25. A method for disseminating alarm messages, the method including
receiving, at a control facility of a communication system, via a communication channel, an alarm signal signifying the occurrence of an alarm event;
identifying automatically a source of the alarm signal;
searching automatically an information database of authorized sources of alarm signals to determine whether the source of the alarm signal is an authorized source;
if the source of the alarm signal is an authorized source, determining automatically from an information database containing, for each authorized source, contact details of at least one recipient to whom at least one predetermined alarm message is to be disseminated in response to receipt of an alarm signal, the contact details of said at least one recipient associated with the source of the alarm signal; and
disseminating automatically the at least one predetermined alarm message to the at least one recipient.

26. The method as claimed in claim 25, in which the content of the at least one alarm message is determined, at least in part, by an authorized user of the system associated with the source of the alarm signal in response to which the at least one alarm message is disseminated.

27. The method as claimed in claim 25 or claim 26, in which the information database contains, for each authorized source, an authorized user of the communication system associated with that source, and the method includes the step of automatically searching the information database to identify an authorized user of the communication system associated with the source of the alarm signal.

28. The method as claimed in any one of claims 25 to 27, in which the communication channel is operable by any one of a mobile telecommunication handset or a fixed-line telecommunication handset and the identification of the source of the alarm signal is by means of a caller line identification (CLI) facility configured to identify the communication instrument comprising the source of the alarm signal.

29. The method as claimed in claim 28, in which the CLI facility is configured to identify the communication instrument associated with the authorized user as a function of the telephone access number of that communication instrument stored in the information database.

30. The method as claimed in any one of claims 25 to 29, in which the at least one predetermined alarm message is a voice message and is disseminated by means of a voice dissemination means.

31. The method as claimed in any one of claims 25 to 29, in which the at least one predetermined alarm message is a data transmission and is disseminated by means of a data dissemination means.

32. The method as claimed in claim 30, in which the voice dissemination means includes a fixed-line telecommunication network.

33. The method as claimed in claim 30, in which the voice dissemination means includes a mobile telecommunication network.

34. The method as claimed in claim 31, in which the data dissemination means comprises a messaging facility.

35. The method as claimed in claim 34, in which the messaging facility is a Short Message Service (SMS) messaging service of a mobile telecommunication network.

36. The method as claimed in claim 34, in which the messaging facility is an Internet-based electronic mail service.

37. The method as claimed in claim 25, in which the information database includes, for each authorized user, parameters relating to operation of the dissemination means, and the method includes operating the dissemination means in accordance with the said parameters.

38. The method as claimed in claim 32 or claim 33, in which the information database includes, for each authorized user, parameters relating to operation of the dissemination means including the number of times a telephone access number should be re-tried in the event of an unsuccessful dissemination of predetermined alarm message, and a number of rings allowed before a telephone call is deemed unsuccessful, and the method includes operating the dissemination means in accordance with the said parameters.

39. The method as claimed in any one of claims 33 to 36, in which the information database includes, for each authorized user, parameters relating to operation of the dissemination means including the number of times a messaging address should be re-tried in the event of an unsuccessful dissemination of predetermined alarm message.

40. The method as claimed in claim 25, in which the control facility has a plurality of access addresses for accessing by the at least one communication channel to receive the alarm signal and in which the information database has a plurality of sets of contact details of recipients and a plurality of alarm messages associated with at least one of the authorized sources, each set of contact details and each alarm message being associated with a respective one of the access addresses of the control means, the method including the steps of
identifying the access address accessed in receiving the alarm signal; and
disseminating a preselected message to a set of recipients associated with the respective access address at which the alarm signal is received.

41. The method as claimed in claim 27, in which the control facility has a plurality of access addresses for accessing by the at least one communication channel to receive the alarm signal and in which the information database has a plurality of sets of contact details of recipients and a plurality of alarm messages associated with at least one of the authorized users of the system, each set of contact details and each alarm message being associated with a respective one of the access addresses of the control means, the method including the steps of
identifying the access address accessed in receiving the alarm signal; and
disseminating a preselected message to a set of recipients associated with the respective access address at which the alarm signal is received.

42. The method as claimed in any one of claims 25 to 41, which includes billing an authorized user for use of the system.

43. The communication system as claimed in claim 22 or claim 23 in combination with a plurality of mobile telephones, each mobile telephone being operable to provide a source of an alarm signal and in which the control facility of the communication system is accessible by a mobile telephone network.

44. The communication system as claimed in claim 1 in combination with a plurality of transmitters, each of which is locatable on a vehicle to be protected and activatable to transmit an alarm signal via a mobile telephone network on detection of unauthorized tampering with the vehicle, thereby providing a source of an alarm signal and in which the control facility of the communication system is accessible by a mobile telephone network.

45. A communication system substantially as herein described and illustrated with reference to the accompanying diagrammatic drawings.

46. A method for disseminating alarm messages substantially as herein described with reference to the accompanying diagrammatic drawings.
